(19) United States
(12) Patent Application Publication
(10) Pub. No.: US 2023/0368521 A1
(43) Pub. Date: Nov. 16, 2023

(54) AUTONOMOUS COGNITIVE INSPECTION

(71) Applicant: Kyndryl, Inc., New York, NY (US)

(72) Inventors: Sarbajit K. Rakshit, Kolkata (IN); Laxmikantha S. Nanduru, R K Puram Post (IN); Anil K. Narigapalli, Hyderabad (IN); Pritpal S. Arora, Bangalore (IN)

(21) Appl. No.: 17/662,947

(22) Filed: May 11, 2022

(51) Int. Cl. G06V 20/17; B64C 39/02; B64D 47/08

(52) U.S. Cl. CPC G06V 20/17; B64C 39/024; B64D 47/08; B64C 2201/123

(57) ABSTRACT

A method, computer program product, and system include a processor(s) obtaining an instruction to perform an inspection of a given type at a geographic site. The processor(s) deploys a robotic drone to the geographic site, wherein based on the deployment, the robotic drone performs a contextual analysis on the geographic site to identify a use case and to collect locational data. The processor(s) obtains the locational data. Based on the locational data, the given type of the inspection, and the use case, the processor(s) generates an inspection plan comprising tasks. The processor(s) identifies robotic drone(s) to complete the tasks and distributes the tasks. The robotic drone( )automatically self-optimize/s to complete the tasks. The processor(s) obtain the collected data from the self-optimized identified one or more robotic drones. The processor(s) analyze the collected data to identify issue(s) at geographic site.

### BACKGROUND

Programmable machines, including robots, are deployed in industrial settings which could be hazardous to humans, including but not limited to industrial shopfloors and large manufacturing and assembly sites. In addition to being used for assembly-related tasks (e.g., welding, chemicals mixing, painting), these robots can also be utilized in quality control tasks in these industrial settings, including in performing inspections of the premises. For example, robots can be programmed to perform inspections at set intervals, including but not limited to, weekly, quarterly, randomly and/or on continual basis. The frequency of the inspections can be adjusted in accordance with use cases. In performing these inspections, the robots are limited to operations which are specific and repetitive tasks. These operations are also controlled and managed by human operators. Thus, the human operator provides the intelligence informing the inspections, including any reasoning and analysis related to information gathered by the robots.

Humans can perform inspections without the assistance of robotic systems but there are shortcomings to this approach, particularly when the environment being inspected contains physical hazards. For example, environmental hazards can limit the quality of the information gathered by an individual. In some instances, only significant surface level defects are detected and damage beneath the surface is not detected. Human inspectors take longer than mechanized inspection methods in accurately detecting displacement of parts or miscalibration of systems in the environment. Human inspectors are sometimes prone to misinterpreting various flaws observed, including but not limited to underestimating or overestimating the impact or potential impacts of these flaws.

Thus, while human inspections are prone to human error and challenged by environmental hazards, robotic inspections only improve these issues by lessening challenges presented by the environmental hazards on the inspection results. Robotic inspections confer this limited benefit because they are presently constrained to specific and repetitive tasks with any analysis or reasoning still being left to the human operator. Thus, although deploying robots can spare humans interactions with certain environmental hazards, many of the shortcomings of inspections performed by humans are still present with the addition of the robotics.

### SUMMARY

Shortcomings of the prior art are overcome, and additional advantages are provided through the provision of a method for performing a cognitive autonomous inspection. The method includes, for instance: obtaining, by one or more processors, an instruction to perform an inspection of a given type at a geographic site; deploying, by the one or more processors, a robotic drone to the geographic site, wherein based on the deployment, the robotic drone performs a contextual analysis on the geographic site to identify a use case and to collect locational data; Obtaining, by the one or more processors, the locational data; based on the locational data, the given type of the inspection, and the use case, generating, by the one or more processors, an inspection plan comprising tasks; identifying, by the one or more processors, one or more robotic drones to complete the tasks and distributing, by the one or more processors, the tasks to the identified one or more robotic drones, wherein based on obtaining the tasks, the one or more robotic drones automatically self-optimize to complete the tasks; obtaining, by the one or more processors, the collected data from the self-optimized identified one or more robotic drones; and analyzing, by the one or more processors, the collected data to identify one or more issues at the geographic site.

Shortcomings of the prior art are overcome, and additional advantages are provided through the provision of a computer program product for performing a cognitive autonomous inspection. The computer program product comprises a storage medium readable by a one or more processors and storing instructions for execution by the one or more processors for performing a method. The method includes, for instance: obtaining, by the one or more processors, an instruction to perform an inspection of a given type at a geographic site; deploying, by the one or more processors, a robotic drone to the geographic site, wherein based on the deployment, the robotic drone performs a contextual analysis on the geographic site to identify a use case and to collect locational data; obtaining, by the one or more processors, the locational data; based on the locational data, the given type of the inspection, and the use case, generating, by the one or more processors, an inspection plan comprising tasks; identifying, by the one or more processors, one or more robotic drones to complete the tasks and distributing, by the one or more processors, the tasks to the identified one or more robotic drones, wherein based on obtaining the tasks, the one or more robotic drones automatically self-optimize to complete the tasks; obtaining, by the one or more processors, the collected data from the self-optimized. identified one or more robotic drones; and analyzing, by the one or more processors, the collected data to identify one or more issues at the geographic site.

Shortcomings of the prior art are overcome, and additional advantages are provided through the provision of a system for performing a cognitive autonomous inspection. The system includes a memory, one or more processors in communication with the memory, and program instructions executable by the one or more processors via the memory to perform a method. The method includes, for instance: obtaining, by the one or more processors, an instruction to perform an inspection of a given type at a geographic site; deploying, by the one or more processors, a robotic drone to the geographic site, wherein based on the deployment, the robotic drone performs a contextual analysis on the geographic site to identify a use case and to collect locational data; obtaining, by the one or more processors, the locational data; based on the locational data, the given type of the inspection, and the use case, generating, by the one or more processors, an inspection plan comprising tasks; identifying, by the one or more processors, one or more robotic drones to complete the tasks and distributing, by the one or more processors, the tasks to the identified one or more robotic drones, wherein based on obtaining the tasks, the one or more robotic drones automatically self-optimize to complete the tasks; obtaining, by the one or more processors, the collected data from the self-optimized identified one or more robotic drones; and analyzing, by the one or more processors, the collected data to identify one or more issues at the geographic site.

Methods, computer program products, and systems relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts a workflow that includes various aspects of some embodiments of the present invention;

FIG. 2 depicts a workflow that includes various aspects of some embodiments of the present invention;

FIG. 3 depicts a workflow that includes various aspects of some embodiments of the present invention;

FIG. 4 depicts a workflow that includes various aspects of some embodiments of the present invention;

FIG. 5 depicts various aspects of a drone utilized in embodiments of the present invention;

FIG. 6 depicts on embodiment of a computing node that can be utilized in a cloud computing environment;

FIG. 7 depicts a cloud computing environment according to an embodiment of the present invention; and

FIG. 8 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

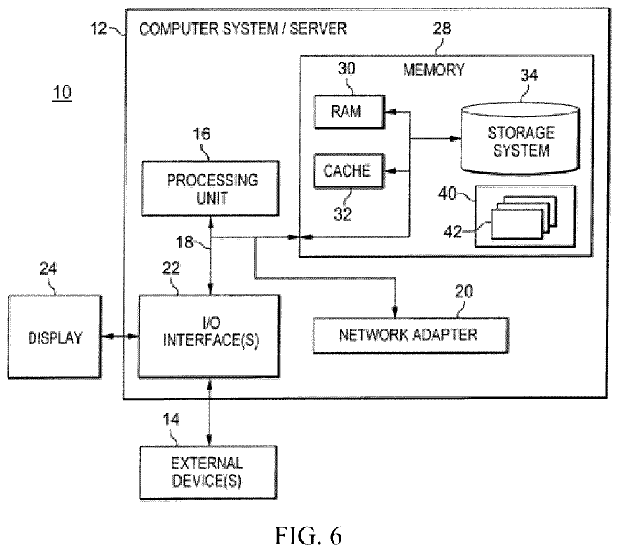

As understood by one of skill in the art, program code; as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 6 as program/utility 40, having a set (at least one) of program modules 42, may be stored in memory 28.

At industrial facilities of different types, regular inspections are performed to maintain these facilities and to ensure safety and efficiency of the facilities. Types of inspections performed can include, but are not limited to, production and/or manufacturing inspections (e.g., pre-production, in-line, and final), which test if the manufacturing and assembly process is complete, including if there exist defects in the manufacturing or assembly processes (e.g., defects in welding, painting, assembling, etc.). Regulatory and compliance inspections are performed to certify certain types of equipment as being free of manufacturing defects before they are deployed. Other types of inspections include product life cycle inspections, and/or quality assurance and/or control inspections.

Generally speaking, inspections are performed, in part, to determine whether there are defects in products or sub-units that do not satisfy their intended use. As will be discussed herein, trained robotic drones can perform these activities more effectively than humans, especially where complex, large systems are assembled, Features of drones which enable enhanced inspection functionality beyond what is capable for human inspectors include: 1) increases in accuracy, flexibility, reliability, and speed; 2) inspection plan diversity as multiple recipes can be utilized for different jobs; 3) ability to conduct the inspections in a dark room, which avoids variations in illumination adversely impacting results; 4) smart configurations with vision sensors, scanners etc.; and/or 5) line integration with barcode readers/applicators etc. Programmed drones can perform industrial inspection methods including, but not limited to, penetrant inspection, x-ray inspection, computed tomography, visual inspection; ultrasonic testing, eddy current inspection, hardness inspection, magnetic particle inspection, and/or thermography.

Two known issues with current approaches to inspecting industrial sites compromising the quality of the inspections are negotiating hazards (e.g., ergonomic, safety, biological, chemical, work organization, etc.) at (geographic/physical) inspection sites and introducing human errors into the inspection results. Current inspection approaches that utilize robotic elements in inspections only mitigate the first issue. Specifically, utilizing robotic assistance in the inspection of environments that contain potential hazards for human inspectors can alleviate safety concerns, but does not address shortcomings introduced by vesting the intelligence of the inspection solely with the human inspector. In existing robotic inspection configurations, robots perform tasks that are specific, repetitive, and during this performance, are controlled and managed by human operators. It is the human operator who provides the intelligence informing the inspections, including any reasoning and analysis related to information gathered by the robots. Various embodiments of the present invention address both the first and the second issue by providing a system, method, and computer program product that utilizes robotic elements, e.g., unmanned aerial vehicles (UAVs) or drones, but also includes, within the examples described herein cognitive and autonomous functionality such that these examples, when utilized to perform inspections, mitigate the second issue in addition to the first, the human inefficiencies. To that end, in embodiments of the present invention, an industrial inspection drone and/or program code executing on one or more processors in communication with the industrial inspection drone: 1) assesses an inspection site; 2) reconfigures itself based on this assessment to gather onsite data (e.g., to optimize this data gathering); 3) gathers onsite data; 4) generates a workflow and use cases comprising an inspection routine for the inspection site; 5) performs inspections which collect data in accordance with the workflow and use cases; and 6) interprets the collected data to execute or propose actions. By interpreting the collected data and proposing actions, the program code: 1) can recommend and/or perform remedial actions at the inspection site (e.g., corrective actions to elements of the physical environment of the inspection site) and/or 2) update the inspection workflow. Thus, embodiments of the present invention include machine-learning elements that continually improve the inspection routines generated as well as the environments in which they are performed.

Embodiments of the present invention include aspects that provide significant improvements over existing mechanized site inspection systems and methods. Certain existing methods focus on providing additional real-time controls or enhancements for robotic inspection vehicles, including but not limited to providing a robotic entity with powered wheels and a mounted camera that can be moved up or down to traverse in dangerous surfaces, providing a tension-adjusting means for traction elements of a robot to control the tension and shift these components, and/or integrating ultrasonic scanning and imaging devices into a robot. These enhancements add functionality that enables a robotic entity to model, inspect and process the surfaces of complex three-dimensional objects. But embodiments of the present invention can take advantage of these existing improvements, but in contrast to merely enhancing control systems or providing additional technical elements of a given robotic device, embodiments of the present invention include on-going improvements to the inspection process itself. For example, in some embodiments of the present invention, the robotic entities, the drones, are part of an autonomous robotic inspection system and method that can perform end to end inspection workflows in a variety of use cases, cognitively, with self-learning capabilities, using multiple robotic drones of complimentary abilities. The drones utilized in embodiments of the present invention can take advantage of physical enhancements when performing inspections, but unlike in existing systems, embodiments of the present invention include self-learning capabilities and the drones utilized can formulate and conduct inspections autonomously.

Embodiments of the present invention perform inspections autonomously with a self-learning capability. The inspections performed by embodiments of the present invention are superior to human-performed visual inspections, based on the technology and hardware utilized, as well as the (continuously self-updating) plan generated by the program code. Additionally, in embodiments of the present invention, aspects of the workflow provide and/or implement immediate corrective actions. The timing of these corrective actions saves significant costs and expenses in the maintenance of the inspected industrial systems.

In addition to providing significant improvements over existing industrial site inspection methods, as discussed above, embodiments of the present invention are also inextricably linked to computing and directed to a practical application. Aspects of various embodiments of the present invention are inextricably linked to computing at least because various embodiments include one or more of robots/drones and a machine-learning system to intelligently automate the activities of the robots/drones to inspect facilities. As described herein, an inspection routine, including the configuration of the robots/drones utilized in this routine, is developed and automated, utilizing data collected by robots/drones utilizing cognitive analysis and machine learning methods. Thus, the inspection methodology is continuously improved through machine learning. Based on utilizing both the robots/drones and the cognitive analysis and machine-learning described herein, embodiments of the present invention provide a practical application. Examples described herein inspect facilities which are physically challenging or impossible for humans to inspect and based on the analyses performed from the cognitively formulated and continuously improved inspections, as generated by the program code in embodiments of the present invention, the results provided by the inspections are of a higher quality because the methodology eliminates possibilities of introducing human error, a shortcoming of existing inspection methods. Additionally, implementation of the method serves a practical purpose because, as aforementioned, aspects of the workflow provide and/or implement immediate corrective actions both in inspection processes and in elements of the physical environments which the program code inspects.

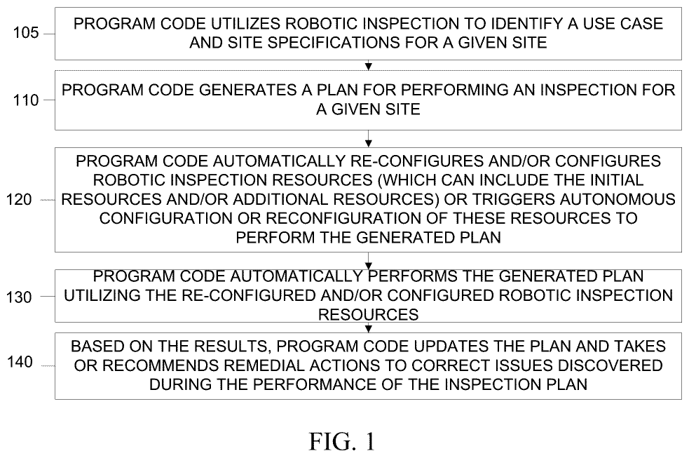

FIG. 1 is a workflow 100 that illustrates various aspects of some embodiments of the present invention. FIG. 1 provides an overview of certain aspects which will be discussed in greater detail herein. As illustrated in FIG. 1, the program code cognitively and dynamically identifies a use case and the site specifications to generate an inspection plan. The program code executes the inspection plan, which includes automatically configuring and re-configuring robotic drones, and tunes the inspection plan (e.g., to align with ground conditions at the inspection site and any changes in the site between the plan generation and execution and based on the analysis performed during the execution of the plan and the results of the execution). A use case is a list of actions or event steps typically defining interactions between a role (known in the Unified Modeling Language (UML) as an actor) and a system, to achieve a goal. The actor can be a human or other external system. The detailed requirements may then be captured in the Systems Modeling Language (SysML) or as contractual statements. Business use cases focus on a business organization instead of a software system. Use cases are utilized to specify business models and business process requirements in the context of business process reengineering initiatives. Use cases are developed within a given context. The context of a use case establishes the metes and bounds of the system.

Referring to FIG. 1, the program code utilizes robotic inspection resources to identify a use case and site specifications for a given site (105). As will be discussed in more detail herein, the program code cognitively and dynamically identifies the use case as well as the specifications of the given site. Based on the use case and the site specifications, the program code generates a plan for performing an inspection for a given site (110). The program code automatically re-configures and/or configures robotic inspection resources (which can include the initial resources and/or additional resources) or triggers autonomous configuration or reconfiguration of these resources to perform the generated plan (120). The program code automatically performs the generated plan utilizing the re-configured and/or configured robotic inspection resources (130). Based on the results, the program code updates the plan and takes and/or recommends remedial actions to correct issues discovered during the performance of the inspection plan (140). As will be discussed later herein, in some examples, when the program code implements improvements (140), it does so as a continuous process, such that the quality of the inspection at the give site is continuously improved, by the program code. In this way, the examples described herein include a continuous self-improvement aspect. Thus, not only can the program code resolve issues identified in the environment during execution of the inspection plan, but, the program code also (continuously) improves the inspection plan itself. For example, program code can determine, from the result of an inspection plan, that certain portions of the plan would be better executed by drones with additional instrumentality. The program code can then update the plan to include deploying drones with this additional instrumentality to execute these portions of the plan.

Returning to FIG. 1, the functionality illustrated in FIG. 1 can be split between a backend system (e.g., one or more servers in a computing environment, including a cloud computing environment), and a front-end system (e.g., intelligent robotic drones which can self-configure based on tasks assigned to the drones by the backend system). In various examples throughout, the functionality and location of the program code initiating various aspects of the invention are distributed differently in the technical environment. The examples herein are non-limiting and are provided for illustrative purposes to demonstrate a shared intelligence approach that can be utilized in embodiments of the present invention.

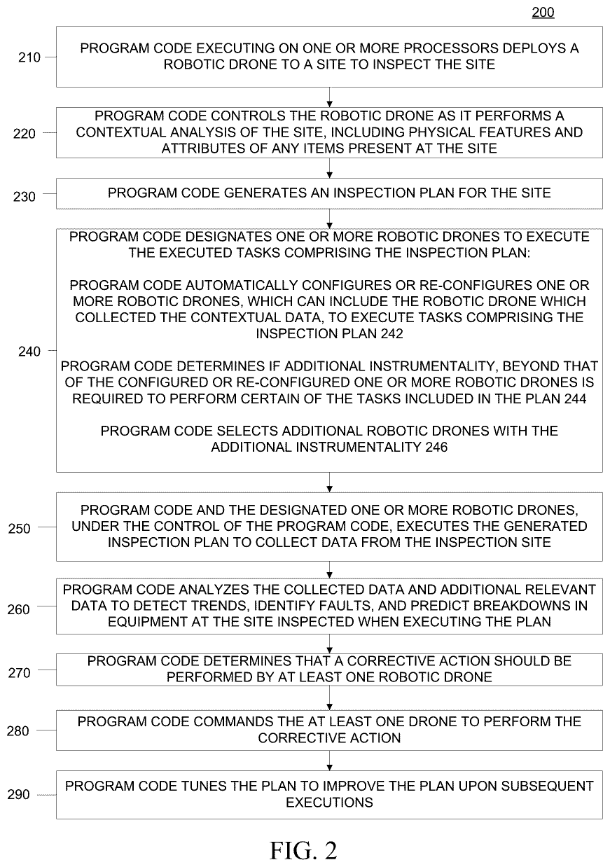

FIG. 2 is also a workflow 200 that illustrates various aspects of some embodiments of the present invention but provides more detail than FIG. 1. In sonic embodiments of the present invention, program code executing on one or more processors deploys a robotic drone to a site (210). It is on this site that an inspection is desired. To deploy the drone to this location, the program code utilizes locational details such as global positioning system (GPS) coordinates. The robotic drone initially deployed to the site can be one or more robotic drones. The program code controls the robotic drone as it performs a contextual analysis of the site, including physical features and attributes of any items present at the site (220).

As explained above in the context of FIG. 1, the program code identifies a use case for a given inspection and then, generates a plan based on the identified use case. These aspects are accomplished based on the processor deploying a robotic drone the site which is to be inspected (210). The program code utilized to control the drone can be understood as an artificial intelligence (AI) enabled computing system. The processors upon which the program code is executed are communicatively coupled to the drone via a communications network, including but not limited to, the Internet. In some embodiments of the present invention, elements of the program code and the processors upon which the code is executed can reside in the physical robotic drone. In some examples, in performing the contextual analysis, the drone, collecting data, and the program code, interpreting the data, together establish the context of the use case, including but not limited to determining the nature of the site (e.g., indoor and/or outdoor site, manufacturing site or end-user site, etc.).

To formulate a use case and enable the program code to generate a plan (e.g., FIG. 110), the artificial intelligence (AI) enabled computing system analyzes the site which is to be inspected. As described below, this analysis can include, but is not limited to: 1) assessing access points of the site; 2) determining the environmental conditions present at the site; and/or 3) determining the functionalities which would be utilized to perform an inspection of the site. These analyses are discussed below.

To formulate a use case and enable the program code to generate a plan, the drone assesses available access points of inspection such that the program code can determine movements of the drone (or drones) to be utilized to reach the points of inspection. Drones can be configured to walk, fly, swim etc. Thus, the program code determines for each access point at the site, what type of drone movement (and thus, drone configuration) can be utilized to access this access point. This contextual analysis can also include the program code determining the types of activities that are relevant for the site (e.g., aerial inspection and capturing video imagery/footage, fetching sample materials for downstream analysis, deeper structural integrity checking through various types of scans, functional testing and verification of equipment, inspection of manufactured products, etc.).

To formulate a use case and enable the program code to generate a plan, in some examples, as part of the contextual analysis, the program code can also determine the environmental conditions (e.g., temperature, lighting etc.) of different locations at the inspection site which would be accessed when performing an inspection. The environmental conditions can impact the instrumentality utilized in the inspection.

To formulate a use case and enable the program code to generate a plan, in some examples, the program code determines the functionalities which would be utilized to perform an inspection of the site. Robotic drones can be equipped with different types of equipment, and depending on the contextual features of the site, which would be surveyed in an inspection, the equipment could vary. These functionalities can include types of instrumentation, sensors, cameras, and other special purpose equipment. Another consideration by the program code in formulating the inspection plan is whether multiple drones of different capabilities would be utilized and coordinating the configurations of these drones to perform the inspection.

Once the program code has performed the contextual analysis of data collected by the robotic drone (220), the program code generates an inspection plan for the site (230). Thus, as noted in FIG. 1, the program code identifies the use case, the program code cognitively and dynamically identifies the site specifications, and the program code formulates the plan. Generating the plan can include identifying the type, sequence, and frequency of inspection tasks to be performed at the inspection site. To formulate the plan, in some embodiments of the present invention, in addition to interpreting the contextual data collected by the robotic drone, the program code accesses a knowledge base and prior history for the site and machine learns the inspection tasks for the site. In generating the plan, the program code can revise these inspection tasks and, in some examples, update the knowledge base, based on the contextual data collected. For example, the prior history can indicate that a flying robotic drone was to collect data at a given access point but no data was collected. Based on the contextual data, the program code determines that the given access point is accessible via a walking robotic drone. Thus, the program code can revise the inspection plan to utilize a walking drone to inspect the given access point.

The program code designates one or more robotic drones to execute tasks comprising the inspection plan (240). As part of designating the one or more robotic drones, the program code automatically configures or re-configures the one or more robotic drones, which can include the robotic drone which collected the contextual data, to execute tasks comprising the inspection plan (242). As the inspection plan was formulated by the program code based on contextual need at the inspection site (230), the program code will configure or re-configure the robotic drones to execute tasks in the plan based on this context. In some embodiments of the present invention, the program code configures or re-configures the one or more robotic drones by determining a mode of movement for each drone it deploys (e.g., walking/crawling/flying/climbing, etc.). The program code will command the one or more robotic drones to dynamically configure themselves to move and/or hover around the points of inspection to perform certain of the tasks. In some embodiments of the present invention, upon obtaining certain tasks in the inspection plan, or upon obtaining the whole inspection plan, the drones will automatically configure or re-configure themselves to execute certain tasks in the plan. Thus, the commands to configure or re-configure the drones can be initiated by program code executing on a computing resource external to the drones or the commands can be initiated by the drones themselves. In some embodiments of the present invention, one drone can communicate with another such that the first drone configures itself and the additional drone to accomplish a task together.

As part of designating the one or more robotic drones, in some embodiments of the present invention, the program code determines if additional instrumentality, beyond that of the configured or re-configured one or more robotic drones is required to perform certain of the tasks included in the plan (244). The program code can make this determination based on the type of inspections to be performed as part of the generated plan. Based on determining that additional instrumentality is to be utilized to complete one or more tasks in the plan, the program code selects additional robotic drones with the additional instrumentality (246). Thus, the designated one or more robotic drones can include additional robotic drones. In these examples, the additional instrumentality can include, but is not limited to, robotic drones mounted with sensors, scanners and other types of instruments, so as to perform the tasks and gather data and/or material samples (for further analysis) from inspection sites. The tasks utilizing the additional instrumentality can also be fulfilled by combining different robotic drones, in which case the program code can instruct certain robotic drones to cluster together, increasing payload capacity to perform tasks in the plan. In some embodiments of the present invention, the robotic drones can also perform distinct tasks with complimentary abilities (e.g., one drone can perform surface scans and take high resolution pictures, while the other can perform acoustic/ultrasonic tests)

Returning to FIG. 2, the program code and the designated one or more robotic drones, under the control of the program code, execute the generated inspection plan to collect data from the inspection site (250). The designated one or more robotic drones gather inspection results, based on executing the tasks in the plan. The designated one or more robotic drones also obtain site information and details of equipment inspected. The program code obtains this data based on communications with the designated one or more robotic drones. In some examples, the designated one or more robotic drones upload their collected data to a central repository and the program code obtains the uploaded data from the central repository for analysis. An earlier described knowledge base may share a server with this central repository and/or these aspects may all reside on different physical computer nodes which are accessible by the program code executing on one or more processors.

The program code analyzes the collected data and additional relevant data to detect trends, identify faults, and predict breakdowns in equipment at the site inspected when executing the plan (260). In some embodiments of the present invention, the program code compares the collected data with relevant data, including but not limited to historical data of prior inspections (e.g., time-series inspection data for various types of sites), and/or a knowledge base curated by humans for various inspection use cases. Based on the comparing, the program code predicts breakdowns in equipment based on patterns the program code identified in the historical data and inferences drawn by the program code between the historical trends and trends in the collected data. Thus, the program code can predict useful life left for a component or for a product inspected by one or more robotic drones.

Based on predicting one or more breakdowns, the program code determines that a corrective action should be performed by at least one robotic drone (270). Corrective actions can include, but are not limited to, tightening joints, replacing specific components, welding parts, and/or painting exposed surfaces, etc. The program code commands the at least one drone to perform the corrective action (280). Thus, based on the commands, the at least one drone performs the corrective action. In some embodiments of the present invention, the program code can also alert a user to the perceived issues through one or more electronic messaging systems. These perceived issues include issues that the program code has inferred from the data (both collected and historical) and/or identified based on analysis of the collected and/or historical data.

In addition to determining that a corrective action should be performed by at least one robotic drone (270), the program code, based on executing the plan and collecting data during the execution, can also improve the plan and thus, in a subsequent inspection of the plan on the site, the program code can implement an enhanced plan. The program code tunes the plan to improve the plan upon subsequent executions (290). The tuning of the plan by the program code can occur both subsequent to each execution and/or during the execution of the plan (e.g., the robotic drones can automatically reconfigure or be reconfigured if they are unable to collect the desired results in their current configurations). The program code can tune the inspection plan to improve it in at least two ways. First, the program code can tune the plan to align with ground conditions at the inspection site and any changes in the site between the plan generation and execution. Second, the program code can tune the plan based on results of the inspection, obtained at any point during the inspection, including the analysis performed by the program code and issues identified by the program code, including defects.

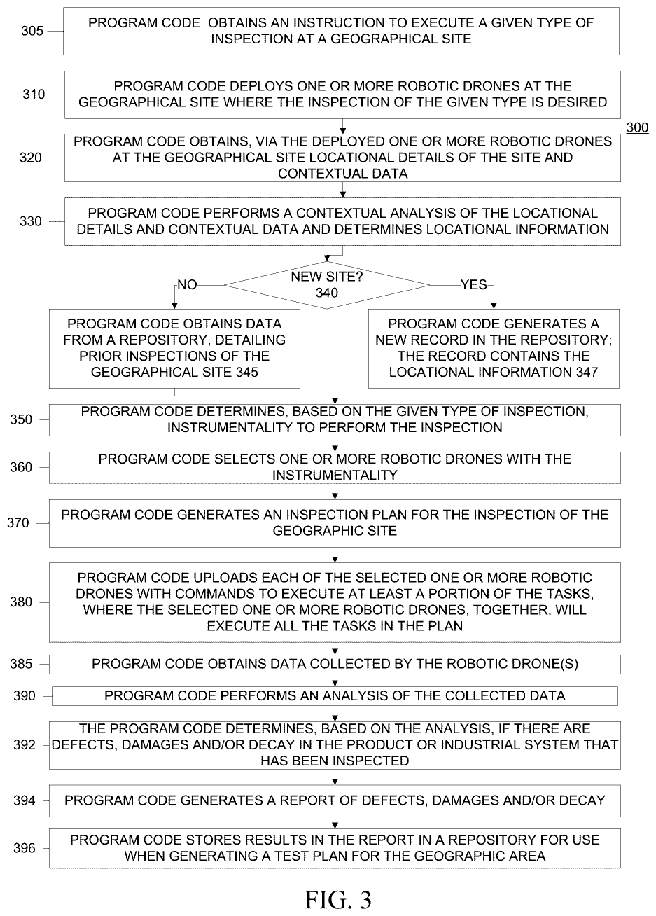

FIG. 3 illustrates a workflow 300 that describes an implementation of aspects of some embodiments of the present invention at an inspection site. FIG. 3 shows an autonomic robotic drone system performing inspection tasks assigned to it In the illustrated embodiment, program code executing on one or more processors obtains an instruction to execute a given type of inspection at a geographical site (305). The program code deploys one or more robotic drones at the geographical site where the inspection of the given type is desired (310). Inspection types include, but are not limited to, production/manufacturing inspections, regulatory and compliance inspections, product life cycle inspections, and quality assurance/control inspections.

The program code obtains, via the deployed one or more robotic drones at the geographical site, locational details of the site and contextual data (320). Based on the locational details and contextual data, the program code performs a contextual analysis of the locational details and contextual data and determines attributes of the site, including but not limited to, nature of the site, landscape and/or terrain comprising the site, to generate locational information (330). In some embodiments of the present invention, program code executing on the drones performs the contextual analysis, based on performing an aerial survey and/or making site data. inferences. The program code analyzes the locational information to determine if the geographical site is a new site or a site that has been inspected in the past (340). Based on determining that the geographical site has been inspected in the past, the program code obtains data from a repository detailing prior inspections of the geographical site (345). Based on determining that the geographical site has not been previously inspected, the program code generates a new record in the repository; the record contains the locational information (347). As discussed earlier, the program code is self-learning and self-improving. Thus, a new inspection of any location can potentially be improved if the program code accesses and analyzes data relevant to past inspections. Thus, if an inspection is needed for a new geographic site, the details are recorded such that the program code can utilize this inspection information in subsequent inspections.

Returning to FIG. 3, the program code determines, based on the given type of inspection, instrumentality to perform the inspection of the geographic site (350). The instrumentality includes, but is not limited to, what types of sensors, scanners and other capabilities are needed to carry out inspection workflow tasks for an inspection of the given type at the geographic site. The program code selects one or more robotic drones with the instrumentality (360). The selected one or more robotic drones comprise appropriate capabilities and equipment, which is mounted and/or fitted in the drones.

The program code generates an inspection plan, based on one or more of the locational data, the data detailing prior inspections, and a knowledge base of requirements for the given type of inspection, comprising tasks for the inspection of the geographic site (370). The program code uploads each of the selected one or more robotic drones with commands to execute at least a portion of the tasks, where the selected one or more robotic drones, together, will execute all the tasks in the plan (380).

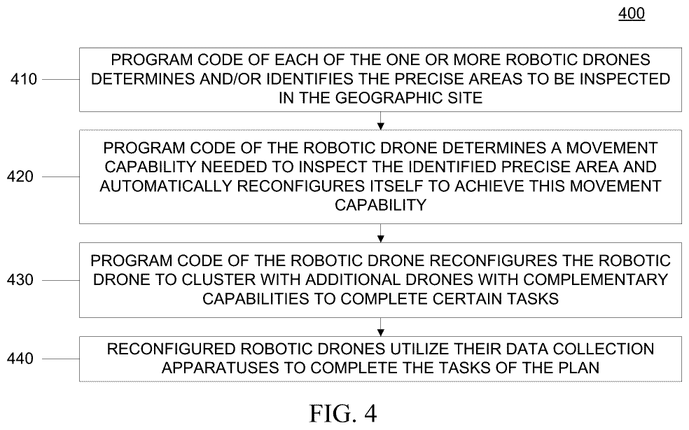

As aforementioned, embodiments of the present invention employ an autonomic robotic drone system that operates to perform the inspection tasks assigned to it. Thus, in some embodiments of the present invention, certain of the intelligence resides within each robotic drone of the one or more robotic drones selected to perform the inspection. Thus, FIG. 4 is a workflow 400 that details the performance of the inspection by the one or more robotic drones after the program code uploads commands to each of the one or more robotic drones.

Referring to FIG. 4, based on the contextual analysis of the geographic site, program code of each of the one or more robotic drones determines and/or identifies the precise areas to be inspected in the geographic site (410). For each of the identified precise areas, the robotic drone determines a movement capability needed to inspect the identified precise area and automatically reconfigures itself to achieve this movement capability (420).

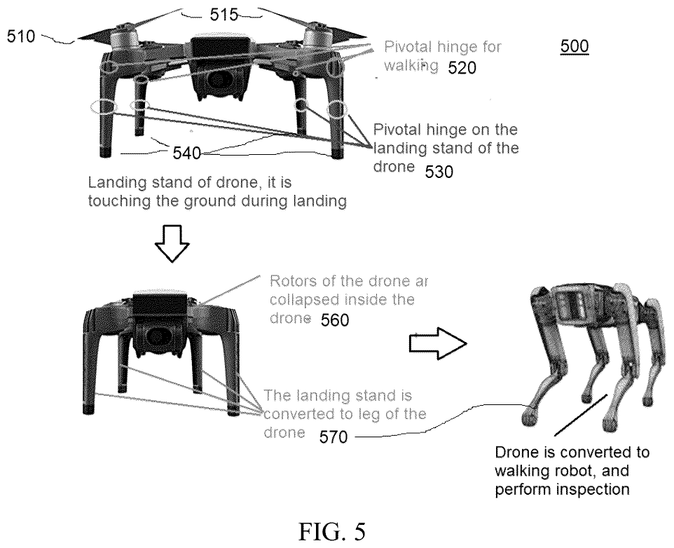

Referring briefly to FIG. 5, FIG. 5 illustrates how a given robotic drone can reconfigure itself to perform tasks in an inspection plan that require specific movement capabilities. In this manner, the robotic drone can operate to perform tasks it was assigned in the inspection plan by the program code. FIG. 5 illustrates how a drone 500 automatically converts itself from a flying drone to a walking drone, based on determining that a task assigned to the drone in the inspection plan requires walking. As illustrated in FIG. 5, a drone 500, in its flying stance 510 includes rotors 515 for flying. The drone 500 also includes pivotal hinges for walking 520, a landing stand 540, and pivotal hinges on the landing stand 530. The landing stand 530 of the drone 500 touches the ground when the drone 500 lands from flying. When the drone 500 converts itself to a walking drone 550, the program code of the drone 500 collapses the rotors inside of the drone 560 and the landing stand becomes the legs 570 of the drone 500. A second view of the walking drone 550 is also provided in FIG. 5.

Returning to FIG. 4, to operate in a manner that will fulfill the tasks in the plan, in some embodiments of the present invention, the program code of the robotic drone reconfigures the robotic drone to cluster with additional drones with complementary capabilities to complete certain tasks (430). Thus, the reconfiguration, which is implemented automatically by the robotic drones, includes two or more of the robotic drones with complementary capabilities dynamically clustering together.

The reconfigured robotic drones utilize their data collection apparatuses to complete the tasks of the plan (440). For example, robotic drones mounted with various sensors, cameras, scanners, etc., scan the inspection areas in the geographic area. In some examples, certain drones can collect samples of material from the inspection site for downstream analysis. The program code of the robotic drones provides the collected data to the program code executing on the one or more processors (e.g., in FIG. 3).

Referring back to FIG. 3, in some embodiments of the present invention, the program code obtains data collected by the robotic drones (385). In some embodiments of the present invention, the drones upload the data they gather to a repository and the program code executing on the one or more processors obtains the data from that repository. In some embodiments of the present invention, the gathered data is analyzed by human operators as this analysis provides supporting evidence of circumstantial data analyzed and outputted by the computing system.

The program code performs an analysis of the collected data (390). This analysis can include comparing the data with previously gathered time-series data (past samples) and manufacturer specifications to detect trends and patterns. The program code determines, based on the analysis, if there are defects, damages and/or decay in the product or industrial system that has been inspected (392). As noted earlier, the program code executing on the one or more processors can access a knowledge base of industrial inspection use cases, check lists, observations/findings/results, tasks and activities, and best practices etc. The program code generates a report of defects, damages and/or decay (394). The program code stores results in the report in a repository for use when generating a test plan for the geographic area (396). These results can be utilized for future (machine-learning) training purposes to improve the accuracy and efficiency of robotic drone systems over time for a variety of inspection use cases.

The program code can make multiple inferences from the inspection data. Defects, damages and/or decay determined by the program code based on the inspection data can include, but are not limited to: faulty components in the inspected areas, wear and tear on the components or full-scale degradation in the inspected equipment, when the inspection site is a production line, incomplete assembly of the product, surface level and sub-surface faults, cracks, or decay such as corrosion or pealing of protective paints etc., parts of equipment that are loose or need recalibration and refitting, gradual decay of the equipment (e.g., the program code can estimate the active life left of the component or system based on its usage to date and other critical inputs such as product specifications).

As aforementioned, the program code generates a report of defects, damages and/or decay (394). Providing this report to human operators outlines to these operators if the inspected equipment is safe for continued use, or if it needs immediate fixes and repairs to maintain safe operability. In sonic examples, the report outlines short term and long-term follow-up actions that operators can consider and act upon, along with associated schedule and cost of such actions. In some embodiments of the present invention, as discussed in FIG. 2, the robotic drones can automatically perform certain of the remediation activities.

Embodiments of the present invention include a computer-implemented method, a computer program product, and a system where program code executing on one or more processors obtains an instruction to perform an inspection of a given type at a geographic site. The program code deploys a robotic drone to the geographic site, where based on the deployment, the robotic drone performs a contextual analysis on the geographic site to identify a use case and to collect locational data. The program code obtains the locational data. Based on the locational data, the given type of the inspection, and the use case, the program code generates an inspection plan comprising tasks. The program code identifies one or more robotic drones to complete the tasks and distributing the tasks to the identified one or more robotic drones, where based on obtaining the tasks, the one or more robotic drones automatically self-optimize to complete the tasks, The program code obtains the collected data from the self-optimized identified one or more robotic drones. The program code analyzes the collected data to identify one or more issues at the geographic site.

In some examples, the program code tunes the inspection plan, For the example, the tuning can include the program code updating the inspection plan to align with attributes selected from the group consisting of: ground conditions at the geographic site and changes in the execution site between generating the inspection plan generation and obtaining the collected data from the self-optimized identified one or more robotic drones, based on the collected data.

In some examples, the program code performs remedial actions, based on the collected data.

In some examples, the program code identifying the one or more robotic drones is based on instrumentality provided in the identified one or more robotic drones.

In some examples, the self-optimization includes activities selected from the group consisting of: altering specific movement capabilities of the identified one or more robotic drones and dynamically clustering a first drone of the identified one or more robotic drones with at least one additional drone of the one or more robotic drones.

In some examples, the first drone of the identified one or more robotic drones and the at least one additional drone provide complementary functionality when clustering.

In some examples, the program code generating the inspection plan comprising tasks further comprises: the program code analyzing the locational data to determine is the geographic site was previously inspected. Based on determining that the geographic site was previously inspected, the program code obtains from a repository, historical records of inspections performed on the geographic site and updates the inspection plan based on the historical records.

In some examples, the program code generating the inspection plan comprising tasks further comprises: the program code analyzing the locational data to determine is the geographic site was previously inspected. Based on determining that the geographic site was not previously inspected, the program code inserts a record for the geographic site in a repository, where the record comprises the locational data.

In some examples, the program code analyzing the collected data to identify one or more issues at the geographic further comprises the program code identifying issues with equipment at the geographic site selected from the group consisting of: defects, damage, and decay.

In some examples, the program code generates a report of the issues. The program code determines if an issue of the issues can be mitigated utilizing a robotic drone outfitted with repair instrumentality. Based on determining that an issue can be mitigated, the program code deploys the robotic drone outfitted with repair instrumentality to mitigate the issue.

In some examples, the program code performing the contextual analysis comprises one or more of the following: the program code determining a nature of the geographic site, the program code assessing available access points of inspection at the geographic site to determine movements of the drone to be utilized to reach the points of inspection, the program code determining types of activities that are relevant for the geographic site, the program code determining environmental conditions of different locations of the geographic site, and/or the program code determining functionalities which would be utilized to perform the inspection of the geographic site.

In some examples, the self-optimization activity comprises altering specific movement capabilities of the identified one or more robotic drones to convert at least one drone from a walking drone to a flying drone.

In some examples, one or more issues are selected from the group consisting of: faults in equipment and predictions for breakdowns in the equipment.

Referring now to FIG. 6, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the one or more processors upon which the program code is executed can each comprise a cloud computing node 10 (FIG. 6) and if not a cloud computing node 10, then one or more general computing nodes that include aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM. DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted; network adapter 20 communicates with the other components of computer system/server 12 via bus 18. It should be understood that although not shown; other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and. virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

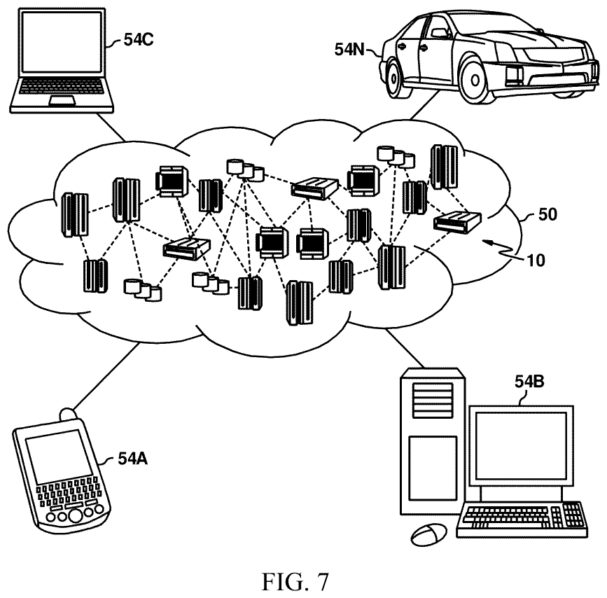

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof, This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection using a web browser).

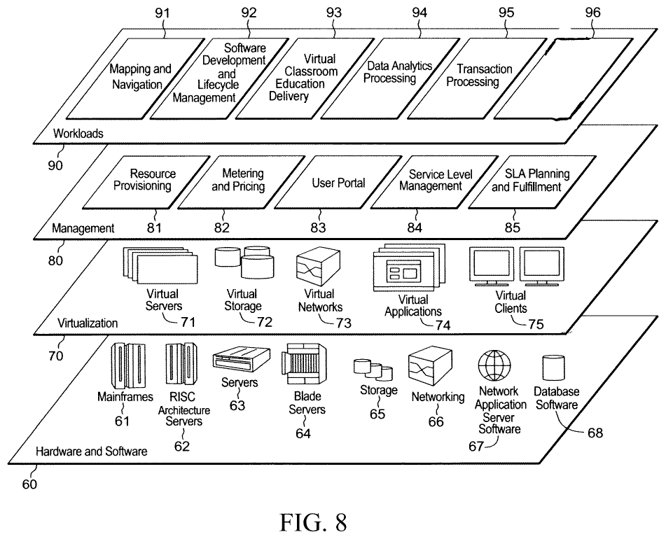

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity-verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automatically and dynamically formulating and performing automated inspections of facilities 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (MD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing de-vices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
obtaining, by one or more processors, an instruction to perform an inspection of a at a geographic site;
deploying, by the one or more processors, a robotic drone to the geographic site, wherein based on the deployment, the robotic drone performs a contextual analysis on the geographic site to identify a use case and to collect locational data;
obtaining, by the one or more processors, the locational data;
based on the locational data, the given type of the inspection, and the use case, generating, by the one or more processors, an inspection plan comprising tasks;
identifying, by the one or more processors, one or more robotic drones to complete the tasks and distributing, by the one or more processors, the tasks to the identified one or more robotic drones, wherein based on obtaining the tasks, the one or more robotic drones automatically self-optimize to complete the tasks;
obtaining, by the one or more processors, the collected data from the self-optimized identified one or more robotic drones; and
analyzing, by the one or more processors, the collected data to identify one or more issues at the geographic site.

2. The computer-implemented method of claim 1, further comprising:
tuning, by the one or more processors, the inspection plan.

3. The computer-implemented method of claim 2, wherein the tuning comprises:
updating, by the one or more processors, the inspection plan to align with attributes selected from the group consisting of: ground conditions at the geographic site and changes in the execution site between generating the inspection plan generation and obtaining the collected data from the self-optimized identified one or more robotic drones, based on the collected data.

4. The computer-implemented method of claim 1, further comprising:
performing, by the one or more processors, remedial actions, based on the collected data.

5. The computer-implemented method of claim 1, wherein identifying the one or more robotic drones is based on instrumentality provided in the identified one or more robotic drones.

6. The computer-implemented method of claim 1, wherein the self-optimization includes activities selected from the group consisting of: altering specific movement capabilities of the identified one or more robotic drones and dynamically clustering a first drone of the identified one or more robotic drones with at least one additional drone of the one or more robotic drones.

7. The computer-implemented method of claim 6, wherein the first drone of the identified one or more robotic drones and the at least one additional drone provide complementary functionality when clustering.

8. The computer-implemented method of claim 1, wherein generating the inspection plan comprising tasks further comprises:
analyzing, by the one or more processors, the locational data to determine is the geographic site was previously inspected;
based on determining that the geographic site was previously inspected:
obtaining, by the one or more processors, from a repository, historical records of inspections performed on the geographic site; and
updating, by the one or more processors, the inspection plan based on the historical records.

9. The computer-implemented method of claim 1, wherein generating the inspection plan comprising tasks further comprises:
analyzing, by the one or more processors, the locational data to determine is the geographic site was previously inspected;
based on determining that the geographic site was not previously inspected, inserting, by the one or more processors, a record for the geographic site in a repository, wherein the record comprises the locational data.

10. The computer-implemented method of claim 1, wherein analyzing the collected data. to identify one or more issues at the geographic further comprises identifying issues with equipment at the geographic site selected from the group consisting of: defects, damage, and decay.

11. The computer-implemented method of claim 10, further comprising:
generating, by the one or more processors, a report of the issues;
determining, by the one or more processors, if an issue of the issues can be mitigated utilizing a robotic drone outfitted with repair instrumentality; and
based on determining that an issue can be mitigated, deploying; by the one or more processors, the robotic drone outfitted with repair instrumentality to mitigate the issue.

12. The computer-implemented method of claim 1, wherein performing the contextual analysis comprises one or more of the following:
determining a nature of the geographic site;
assessing available access points of inspection at the geographic site to determine movements of the drone to be utilized to reach the points of inspection;
determining types of activities that are relevant for the geographic site;
determining environmental conditions of different locations of the geographic site; and
determining functionalities which would be utilized to perform the inspection of the geographic site.

13. The computer-implemented method of claim 6, wherein the self-optimization activity comprises altering specific movement capabilities of the identified one or more robotic drones to convert at least one drone from a walking drone to a flying drone.

14. The computer-implemented method of claim 1, wherein the one or more issues are selected from the group consisting of: faults in equipment and predictions for breakdowns in the equipment.

15. A computer program product comprising:
a computer readable storage medium readable by one or more processors of a shared computing environment comprising a computing system and storing instructions for execution by the one or more processors for performing a method comprising:
obtaining, by the one or more processors, an instruction to perform an inspection of a given type at a geographic site;
deploying, by the one or more processors, a robotic drone to the geographic site, wherein based on the deployment, the robotic drone performs a contextual analysis on the geographic site to identify a use case and to collect locational data;
obtaining, by the one or more processors, the locational data;
based on the locational data, the given type of the inspection, and the use case, generating, by the one or more processors, an inspection plan comprising tasks;
identifying, by the one or more processors, one or more robotic drones to complete the tasks and distributing, by the one or more processors, the tasks to the identified one or more robotic drones, wherein based on obtaining the tasks, the one or more robotic drones automatically self-optimize to complete the tasks;
obtaining, by the one or more processors, the collected data from the self-optimized identified one or more robotic drones; and
analyzing, by the one or more processors, the collected data to identify one or more issues at the geographic site.

16. The computer program product of claim 15, further comprising:
tuning, by the one or more processors, the inspection plan.

17. The computer program product of claim 16, wherein the tuning comprises:
updating, by the one or more processors, the inspection plan to align with attributes selected from the group consisting of: ground conditions at the geographic site and changes in the execution site between generating the inspection plan generation and obtaining the collected data from the self-optimized identified one or more robotic drones, based on the collected data.

18. The computer program product of claim 15, further comprising:
performing, by the one or more processors, remedial actions, based on the collected data.

19. The computer program product of claim 15, wherein identifying the one or more robotic drones is based on instrumentality provided in the identified one or more robotic drones.

20. A computer system comprising:
a memory;
one or more processors in communication with the memory;
program instructions executable by the one or more processors in a shared computing environment of a computing system via the memory to perform a method, the method comprising:
obtaining, by the one or more processors, an instruction to perform an inspection of a given type at a geographic site;
deploying, by the one or more processors, a robotic drone to the geographic site; wherein based on the deployment, the robotic drone performs a contextual analysis on the geographic site to identify a use case and to collect locational data;
obtaining, by the one or more processors, the locational data;
based on the locational data, the given type of the inspection, and the use case, generating, by the one or more processors, an inspection plan comprising tasks;
identifying, by the one or more processors, one or more robotic drones to complete the tasks and distributing, by the one or more processors, the tasks to the identified one or more robotic drones, wherein based on obtaining the tasks, the one or more robotic drones automatically self-optimize to complete the tasks;
obtaining, by the one or more processors, the collected data from the self-optimized identified one or more robotic drones; and
analyzing, by the one or more processors, the collected data to identify one or more issues at the geographic site.
